(19) United States
(12) Patent Application Publication
(10) Pub. No.: US 2017/0082091 A1
(43) Pub. Date: Mar. 23, 2017

(54) Wind turbine

(71) Applicant: Gustaf SÄRNER, Malmö (SE)

(72) Inventor: Gustaf Johannes Särner, Malmö (SE)

(21) Appl. No.: 15/125,528

(22) PCT Filed: Mar. 10, 2015
(86) PCT No.: PCT/EP2015/025012

§ 371 Date: Sep. 12, 2016

(30) Foreign Application Priority Data
Mar. 11, 2014 (SE) 1430034-7

(51) Int. Cl. F03D 9/00; H02K 7/18; F03D 3/06; F03D 3/02; F03D 3/00; F03D 9/25

(52) U.S. Cl. CPC F03D 9/002; F03D 3/005; F03D 9/25; F03D 3/06; F03D 3/02; H02K 7/183; F05B 2220/7066; F05B 2240/214

(57) ABSTRACT

The invention relates to a wind turbine (1) for converting kinetic energy from wind into electrical power, wherein said wind turbine (1) comprises: a rotary part (2, 3, 7) adapted to rotate around an axis of rotation (9) comprising at least one blade (2, 3) for catching the wind, a supporting structure (4, 10, 20) for supporting said rotary part (2, 3, 7) and for fastening said wind turbine (1), said rotary part (2, 3, 7) being rotably connected to said supporting structure (4) so as to allow rotation of the rotary part (2, 3, 7) with low friction to the supporting structure (4). The wind turbine is characterized in that at least one field coil (10, 20) is attached to or integrated into said supporting structure (4), said at least one field coil (10, 20) being adapted to be fed with a direct current (I_{f}) so as to create at least one magnetic field (B) with a field direction perpendicular to said axis of rotation (9), said rotary part (2, 3, 7) comprises at least one conduction wire or winding (7) that is attached to or integrated into said rotary part (2, 3, 7), said conduction wire or winding (7) passing said at least one magnetic field (B) to induce electric current (Iᵢ) in said conduction wire or winding, said supporting structure (4) further comprising a rotary electrical connection (6), being adapted to connect said at least one rotating conduction wire or winding (7) of the rotary part (2, 3, 7) to an electrical outlet (8) of said supporting structure.

### TECHNICAL FIELD

The present invention relates generally to a wind turbine. More particularly, the present invention relates to a wind turbine as defined in the introductory parts of claim 1 and a method for producing such a wind turbine as defined in the introductory parts of claim 15.

### BACKGROUND ART

Renewable energy is becoming ever more important. Wind turbines are however expensive and complex rendering them hard for a small electrical consumer to benefit from. The wind turbines of today are fairly fragile, have many parts that wear and eventually have to be replaced, and often take up a lot of space as they have to be secured by wires. The high price for a wind turbine with an electrical generator attached to the rotation shaft often render the produced power too expensive to compete with the normal power providers in the society.

Vertical wind turbines are one step towards a more robust wind turbine. The other drawbacks above, except being more robust, however, still remains.

Rules for introducing a home or small scale power generator to the electrical grid is also an obstacle in many countries, if at all possible. The electricity has to meet certain standards and it is sometimes very expensive to get approval to connect the wind turbine to the electrical grid as the grid are usually owned by companies who wants to sell electricity, not buy.

Electrical generators for producing 50 Hz or 60 Hz AC power are fairly expensive and require a certain drive rotation speed to produce the correct frequency. To facilitate the correct frequency, a gearbox is usually used between the wind and the electrical generator. The gear box has a lot of moving parts that eventually will wear and need maintenance or replacement. The rotation induced by the wind also has to be transmitted to the electrical generator, which transmission is a further source of losses and may be fragile to outer force.

There is thus a need to facilitate a wind turbine that is simpler and thereby less expensive, that does not need as much maintenance and replacement parts. There is a need for a simple wind turbine that is inexpensive and that will function without maintenance, and if maintenance is needed, it should be limited and inexpensive.

### SUMMARY OF THE INVENTION

It is an object of the present invention to improve the current state of the art, to solve the above problems, and to provide an improved wind turbine that is simple with few parts, inexpensive, and does not require much maintenance or service. These and other objects are achieved by a wind turbine for converting kinetic energy from wind into electrical power, wherein said wind turbine comprises: a rotary part adapted to rotate around an axis of rotation comprising at least one blade for catching the wind, a supporting structure for supporting said rotary part and for fastening said wind turbine, said rotary part being rotably connected to said supporting structure so as to allow rotation of the rotary part with low friction to the supporting structure. The wind turbine is characterized in that at least one field coil is attached to or integrated into said supporting structure, said at least one field coil being adapted to be fed with a direct current (I_{f}) so as to create at least one magnetic field (B) with a field direction perpendicular to said axis of rotation, said rotary part comprises at least one conduction wire or winding that is attached to or integrated into said rotary part, said conduction wire or winding passing said at least one magnetic field (B) during rotation of said rotary part to induce electric current (Iᵢ) in said conduction wire or winding, said supporting structure further comprising a rotary electrical connection, being adapted to connect said at least one rotating conduction wire or winding of the rotary part to an electrical outlet of said supporting structure.

The conduction wire or winding is be integrated in or attached to the rotary part frame that connects the blades together. The frame is connected to the supporting structure via the rotary connection organ. The conduction wire or winding is thus integrated with or attached to the blades and the rotor frame building up one rotary component, the rotary part. The rotary part is adapted to rotate with support of the supporting structure with low friction between the parts. The supporting structure preferably has the field coil(s) integrated or built into the structure so that the supporting structure and the field coil(s) form one component. The magnetic field produced by the field coil is in the center of the coil directed perpendicular to the axis of rotation of the rotary part, i.e. directed inwards towards the center of the wind turbine or outwards in the opposite direction. Electricity is transferred from the rotating conduction winding to the non-rotating supporting structure via the rotary electrical connection. The wind turbine is thus built up by only two main components, making the assembling of the wind turbine simple and leaving few parts that may need maintenance or replacement. The construction is very simple and thus robust. No additional generator is needed as the generator is integrated in the wind turbine's structural parts.

The conduction wire or winding may be as little as one wire running along the blade of the rotary part, the blade being intended to catch the wind and rotate the rotary part, but the conduction wire or winding may also be a winding with a number of turns.

The supporting structure has an electrical outlet being adapted to be connected to an electrical load, e.g. a battery, a heater, an inverter etc. or any other suitable device running on the electricity produced by the wind turbine.

The conduction wire or winding of the wind turbine may be integrated in said at least one blade and arranged along 50-100% of the elongation of said at least one blade. It is preferred that the conduction wire or winding is as long as the field coil is long (in the direction of the axis of rotation, which is the height in a standing normal vertical wind mill configuration) so that the conduction wire or winding will sweep by the entire magnetic field of the field coil. It is preferred that the field coil is substantially as long (in the direction of the axis of rotation) as the blades and that the conduction wire or winding is as long as the blades, following the blade elongation of the blade. It is naturally preferable that the conduction wire or winding passes the field coil as close as possible to ensure that the magnetic field is as strong as possible. The distance between the conduction wire and the field coil is preferably a few centimeters or less, preferably only a few millimeters. By using the outermost parts of the rotary part for the conduction winding the speed of the rotating conduction winding passing the magnetic field is maximized during the rotation (as the axial distance is maximized) and the magnetic field is utilized to as much as possible, as the magnetic field is the strongest close to the end of the field coil. That will maximize the voltage induced in each turn of the conductive winding.

The conduction wire or winding is in one embodiment of the invention directed in a direction parallel to the axis of rotation, e.g. following wing blades that have an elongation also arranged parallel to the axis of rotation. Each blade may also have more than one conduction wire or winding attached, the conduction wires or windings being spaced apart in the direction of rotation of the rotary part. In that way current is induced subsequently in neighboring conduction wires as they pass the magnetic field of the field coil. If the field coil is narrow in annular direction of the wind turbine, current is then induced in at least one of the wires during a longer time period than if having only one wire or having a coil with many turns of wire. Using simple rectifying means, the current induced in each wire of a blade may be connected to a single conductor leading from the blade to the rest of the rotary part or directly to the rotary electrical connection. Each conduction wire or winding is e.g. connected in series to a rectifier unit, each wire and rectifier unit being connected in parallel with each other. As the conduction wires pass the filed coils, several or at least one may induce current to said power outlet at each point in time.

The wind turbine according to the invention may have two blades of the rotary part that are spaced 180° apart in the rotary direction and span and support at least one conduction winding so that the height of the conduction wire or winding is substantially the same as the height of the blades and the width of the conduction wiring is substantially the same as the diameter of the rotary part. If field coils also are arranged 180° apart, having a magnetic field in the same direction, the current will be induced in the winding from magnetic fields of two field coils simultaneously, driving a current in the winding.

The wind turbine may further preferably have a rotary part that comprises four or more blades, wherein each blade or each oppositely arranged blade pair span and support one conducting winding. An even number of field coils are then preferable, each pair being oppositely arranged (180° between the blades).

If the wires of the blades are not connected with oppositely arranged wires, the field coils may be directed differently, e.g. so that the magnetic fields of all field coils are directed inwards or outwards from the center of the wind turbine. In that case an odd number of blades and/or field coils may be used.

It is preferred that the at least one field coil is elongated with a height in a direction parallel to the rotation axis of rotation that is 50-100% of the height of the at least one blade. It is preferred that the field coil is as long as the wire of the blade, to utilize all of the magnetic field of the field coil.

The at least one field coil may be wound around a magnetic core having a permeability that is higher that the permeability of air. The core preferably has a high permeability as, e.g. iron, steel or any other material with high permeability. As is generally known, the magnetic core of a coil will magnify the magnetic field with a factor equal to the permeability.

In one embodiment of the wind turbine according to the invention, each field coil is integral with a pillar, said pillar being parallel to said axis of rotation and being part of said supporting structure. Each field coil may thus be fully integrated into or fixedly attached to the pillar. Each field coil may also be the only part or the major part of each pillar.

The wind turbine according to the invention may comprise more than one field coil, preferably more than two field coils, most preferably more than three field coils. Four, five or six field coils may e.g. be advantageous dependent on how they interact with the induction wires of the blades. In one embodiment of the invention the number of field coils is chosen so that at least one wire always passes a field coil/pillar of the wind turbine. In that way electricity is always induced in at least one wire.

The wind turbine according to the invention may in a further embodiment comprise a plurality of field coils, stacked on top of each other and being integrated into a pole/pillar of the supporting structure, wherein the magnetic fields of all coils within each pole or pillar are directed in the same direction, such that the combined magnetic field is equivalent to having only one coil. Standardized electromagnets may then be used and stacked in each pole pillar. The electromagnets are then connected so as to create a magnetic field in the same direction so that they together present a fairly uniform magnetic field, similar to a single electromagnet as in the previous embodiments, to the conduction winding.

The wind turbine according to the invention is preferably of a vertical wind turbine type wherein, the axis of rotation is either vertical or horizontal and the blades are elongated and extend in an axial direction. A vertical axis of rotation is normally preferred, but in some cases, e.g. for utilizing wind flowing past a roof, a horizontal axis of rotation may be advantageous. The two variants are the same, just tilted 90°.

Said vertical wind turbine type may in one embodiment have a short axial direction and a wide radius.

In a further embodiment of the present invention the blades are directed in a radial direction to the axis of rotation to form a very simple rotor for catching the wind. The conduction wire or winding then extend along the edges of the blade, so that the conduction wire or winding rotate close past the filed coils of the supporting structure.

According to a further aspect of the present invention the field coils are fed by parts of the electricity induced by the conduction winding, these parts being fed as direct current (DC) and thus the voltage induced in the conduction winding may be controlled by how large part of said DC electrical output that is fed to the field coils. The rotational resistance inflicted on the induction winding in the rotary part will also be affected by the strength of the magnetic field (B) induced by the field coils. In that way the rotational speed of the wind turbine may also be controlled by controlling the DC-current fed to the filed coils. If the wind turbine should be used for producing AC power, the rotational speed will be important and may in this way be controlled without a gear box.

According to another embodiment of the present invention the supporting structure spans a volume that confines all or at least a substantial part of said blades. The supporting structure then also protects the rotary parts from outer damage. A net could be attached on the outside of the supporting structure to protect the rotary wings even more from flying objects.

According to another embodiment of the present invention the wind turbine further comprises a second rotary part comprising blades and conduction windings that are adapted to rotate on the outside of said supporting structure. There will thus be an inner rotary part having conduction windings rotating in the magnetic fields of the field coils on the inside of the field coils and one on the outside of the field coils. In that way the magnetic field produced by the field coils is used twice, both on the inner side of the field coils and on the outside of the field coils. The inner and outer rotary parts may rotate in the same or in opposite rotary directions.

According to a still further embodiment of the wind turbine according the present invention, the blades of said rotary part are adapted to rotate only on the outside of said at least one field coil and said supporting structure.

It is further preferable that said rotary part is rotably connected to said supporting structure via a rotary connection organ. This rotary connection organ has the purpose to facilitate low friction rotation of the rotary part. The rotably connection organ could be a slide bearings, a ball bearing, a plain bearing, a magnetic bearing, a fluid bearing or any other element suiting the purpose.

The rotably connection organ could be placed where the rotation axis crosses the supporting structure, i.e. in a small shaft bearing in the center, but the bearing could also be a ring bearing having a diameter as big as the rotary part. Especially a slide bearing may be advantageous to make large so as to reduce the friction per surface area and thereby reduce wear.

According to one embodiment of the invention the supporting structure is shaped so as to direct the wind in one of the possible rotation directions of the wind turbine. This could be made by making parts of the supporting structure that are parallel to the rotation axis oblong in the radial direction and tilt the elongated cross section a few degrees.

The blades of the rotary part of any one of the embodiments above may be of Darrieus type, Giromills type, Helical blades, or any other common blade type for vertical wind turbines or a combination thereof. Regardless of the blades used, it is however desirable to fasten/integrate the conduction winding at the radial periphery of the blades so as to maximize the velocity of the rotating conduction winding and to bring the conduction winding as close to the field coils as possible during rotation.

The support structure may have any shape, e.g. the shape of the edges of a cube; four or more poles/pillars forming a standing cylinder joined by a top ring or circular top and/or a bottom ring or a circular bottom, wherein at least two pairs of poles/pillars are utilized as said field coils; said cylinder laying down; a central pole around which the blades are rotating, crossed in 90° by a second pole holding said field coils. For practical reasons, since it is practical to have blades that are straight in the axial direction, a cylinder form is reasonable, integrating the field coils in said poles/pillars.

It is further preferable that the wind turbine according to the present invention has fastening organs on the supporting structure so that the wind turbine may be fastened to a pole or a roof, so that wires for stabilizing the wind turbine may be fastened and so that multiple wind turbines may be stackable on top of each other and/or beside each other. When stacking the wind turbines side by side in a row the magnetic field of neighboring field coils should be in the same direction so as to magnify the magnetic field.

According to a further different aspect of the present invention an even number of four or more poles are used for the supporting structure and each pair of poles are used to build up a at least two field coils, wherein said at least two field coils are parallel to each other, wound in the same direction, connected in series, and fed with a direct current (I_{f}) so as to create a substantially uniform magnetic field (B) through the field coils and the space between them. The rotary part may rotate inside the uniform field inside the supporting structure or on the outside of the supporting structure. If this embodiment is implemented with two field coils (i.e. two pairs of poles), the filed coils will then form a Helmholtz coil inside which or outside which the rotary part may rotate.

As the conduction wires are placed on the blades (i.e. the wings) of the wind turbine, the wires will reduce icing during cold weather when current is induced in the wires. If icing is detected on the blades, the wires could temporary be fed with high current to induce heat for de-icing of the blades.

The invention further concerns a method for manufacturing a wind turbine of above, the method comprising the steps of: mounting and/or integrating conduction winding to the rotary part, mounting the supporting structure to the mounted rotary part, attaching the conduction winding to the rotary electrical connection, arranging or integrating the winding of the at least one field coil to the supporting structure, connecting all field coils in series, connecting the field coils to a DC source.

It should be noted that obvious variations of the invention described above are understood and are contemplated in the scope of the invention. It is e.g. obvious that the radius and height of the rotary part could vary from what is described above. The skilled person understands that the features of the devices above could be contemplated also for the inventive method with the same advantages as for the devices.

### BRIEF DESCRIPTION OF THE DRAWINGS

The above objects, as well as additional objects, features and advantages of the present invention, will be more fully appreciated by reference to the following illustrative and non-limiting detailed description of preferred embodiments of the present invention, when taken in conjunction with the accompanying drawings, wherein:

FIG. 1 is a schematic and perspective view of the principle of the present invention having only two blades, and one conduction winding. Two field coils are integrated into the supporting structure. The rotary part rotates within the supporting structure.

FIG. 2 is a schematic and cross-sectional top view of the inventive wind turbine of the same type as in FIG. 1, but having four field coils and six blades.

FIG. 3 is a schematic and perspective view of the principle of the present invention having only two blades, and multiple conduction windings spaced apart on the blade. Two field coils are integrated into the supporting structure. The rotary part rotates within the supporting structure.

FIG. 4 is a schematic and cross-sectional top view of the inventive wind turbine of the same type as in FIG. 3, but having four field coils and six blades.

FIG. 5 is a schematic and cross-sectional top view of the inventive wind turbine of FIG. 4 having a different conduction wire configuration.

FIG. 6 is a schematic top view of a wind turbine of FIG. 2, with the addition of a second outer rotary part with six additional blades.

FIG. 7 is a schematic and perspective view of a further embodiment of the present invention having only one blade, and one conduction winding. The blade is directed in the radial direction to said axis of rotation. Two field coils are integrated into the supporting structure. The rotary part rotates within the supporting structure.

FIG. 8 is a schematic and perspective view of a further embodiment of the present invention having only two blades, and one conduction winding. Fourteen field coils are integrated into each vertical pole of the supporting structure. The rotary part rotates within the supporting structure.

FIG. 9 is a schematic and perspective view of the principle of a second aspect of the present invention having only two blades on an inner rotary part, and one conductive winding. The supporting structure has three field coils and form the structure of a standing cylinder with eight poles creating a substantially uniform magnetic field inside of it.

FIG. 10 is a schematic top view of a wind turbine according to the second aspect of the present invention of FIG. 9 having the same supporting structure as the wind turbine of FIG. 3 but having a rotary part having six blades.

### DETAILED DESCRIPTION OF PREFERRED EMBODIMENTS OF THE INVENTION

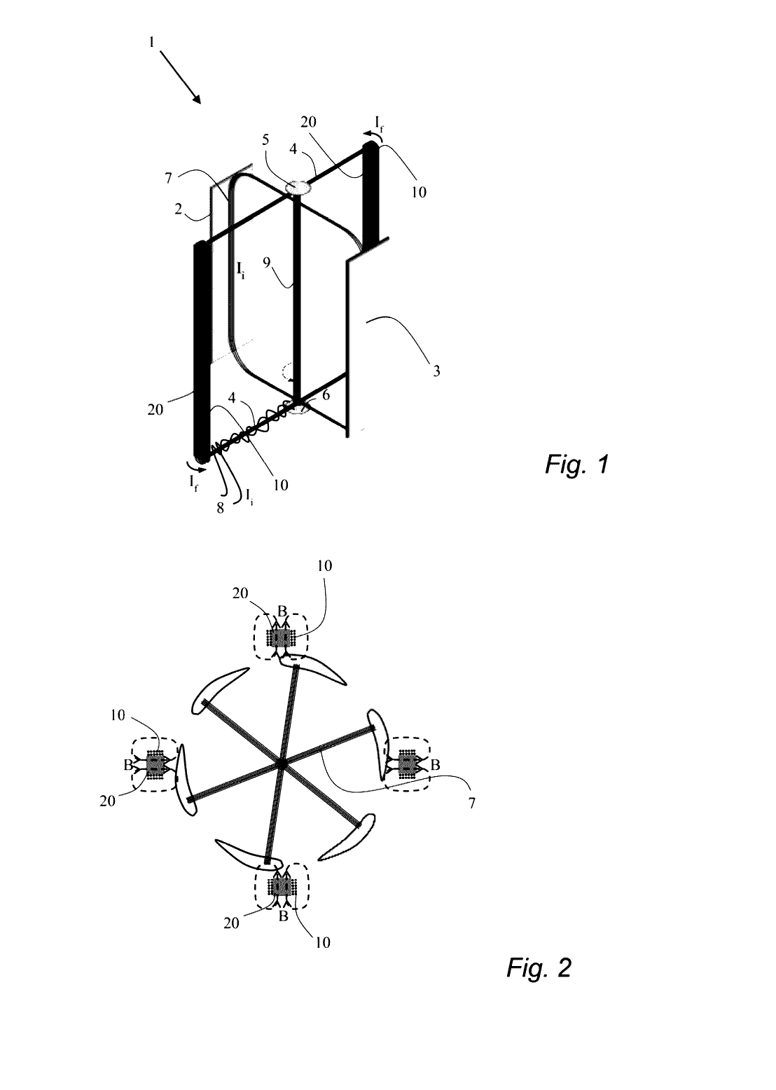

The present invention will now be described in detail with reference to the accompanied drawings. FIG. 1 shows a simple setup of the principle of the wind turbine 1 of the present invention. The rotary part 2, 3, 7 is constructed by a conduction winding 7, two blades 2, 3 and a shaft 9. The rotary part 2, 3, 7 is adapted to rotate around an axis of rotation 9 in the form of shaft 9. Shaft 9 is connected to the supporting structure 4.

A rotary connection organ 5 facilitates a low friction rotation between the rotary part and the supporting structure.

Two field coils 10 are wound around two magnetic core bars 20 making up the poles of the supporting structure 4, inside which supporting structure the rotary part 2, 3, 7 rotates. The field coils 10, 11 are wound in the same direction, connected in series and fed by the direct current I_{f} so as to create identical magnetic fields B over the rotating part 2, 3, 7 when the pass by the poles. At the time frame when the conduction winding 7 rotates past the magnetic field B, a current Iᵢ will be induced in the conduction winding. A rotary electrical connection 6 is facilitated to connect the rotating conduction winding to the output cables for the induced current I_{f}.

Direct current parts of the induced current I_{f} may be used to feed the field coils their input current I_{f}.

The induced current Iᵢ is flowing through the conduction winding in one direction when directly passing over the angular position of the field coil, and in the other direction when the conduction winding passes in the empty space between the field coils. This is due to the direction of the magnetic field B being the opposite in those areas, as can be seen in FIG. 2 indicate by the arrows B, indicating the magnetic field direction.

The rotary electrical connection 6 may be of brush-commutator type connection producing a DC output, or if the rotary electrical connection 6 is a slip ring type connector an AC output of very unsymmetrical and bad shape may be achieved.

The width and height of the wind turbine could be from 100 mm to several meters or bigger. The principle will work regardless of the size. To be able to use the wind turbine in urban environments e.g. on the roof top of a domestic house, the width and height are preferably 0.5 m to 2 m. For additional power output several wind turbines could be stacked on top of each other or side by side. If stacked side by side, they are preferably placed so that the magnetic field will continue through at least two of the field coils of the generators, enhancing the induced current.

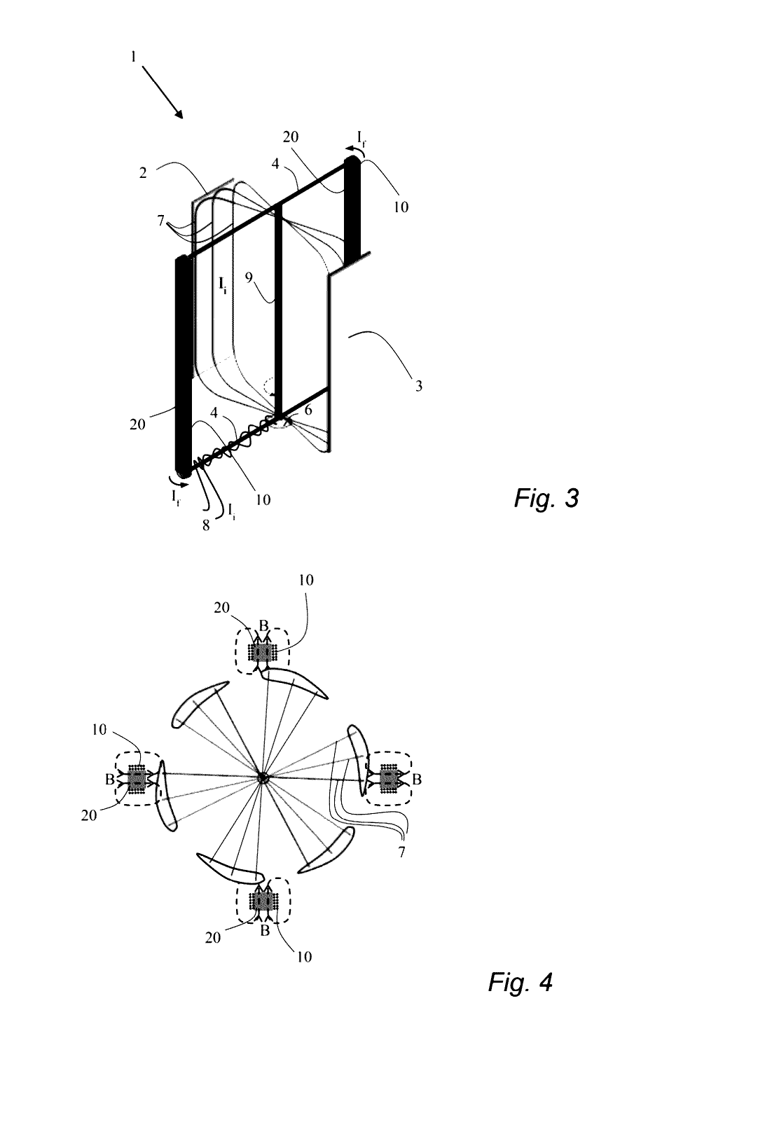

FIG. 3 shows the same type of wind turbine 1 as in FIG. 1 but with a different configuration of the induction winding. Separate windings are used that are spaced apart on each blade so that the time when any wire is passing the field coils will increase. By using rectifiers and an angular distance between the induction wires on a blade that is roughly the same as the angular width of the field coil, and if all induction wires are coupled in parallel to each other, a direct current may be produced during the entire time the blade is passing the field coil/pole 10, 20. The magnetic field B is shown schematically.

FIG. 4 shows the same kind of wind turbine as in FIG. 3, but having four field coils and six wing blades of the rotary part. This configuration is especially advantageous as the field coils/poles affect the wind fairly little as it uses a small portion of the circumference of the wind turbine, but still has enough field coils so that one conduction winding passes a pair of field coils at any given moment. Current is thus inducted using the strong magnetic field just at the field coil in at least one conduction winding at any given time. Using rectifying means, a fairly smooth direct current (DC) may be continuously induced from the wind turbine as long as the wind keeps the rotary part rotating.

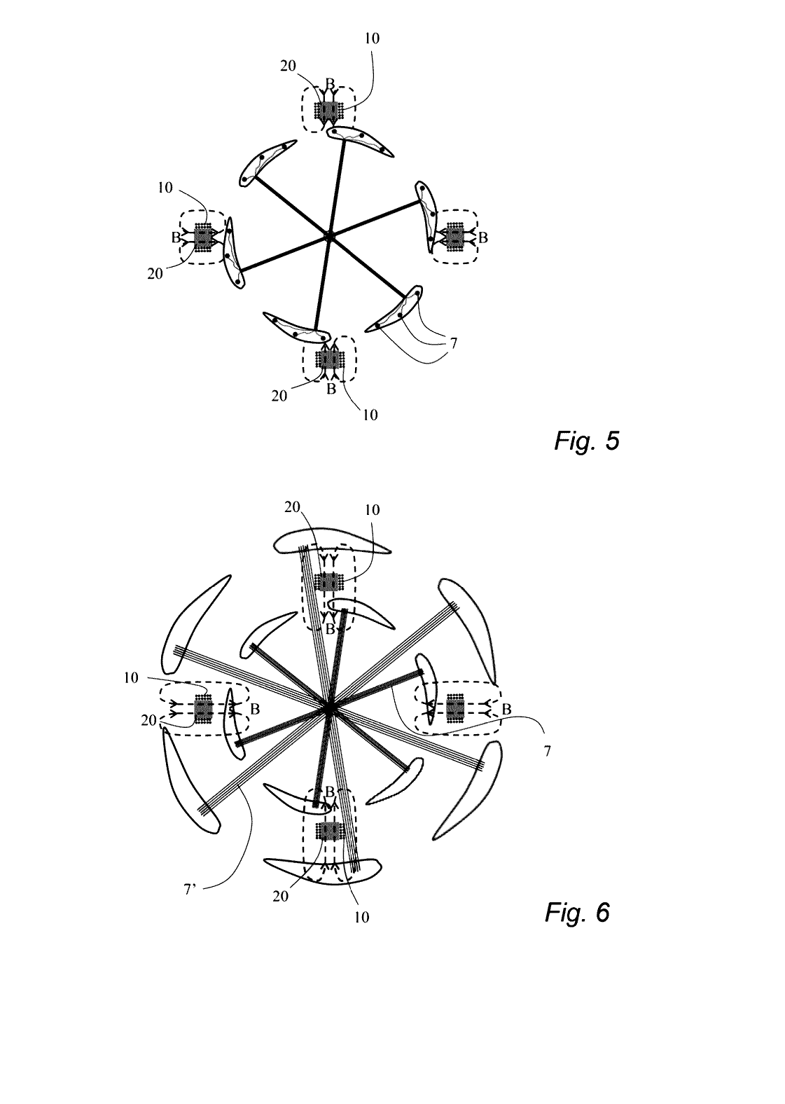

In FIG. 5 the wind turbine of FIG. 4 is modified so that the blades of the rotary parts have single conduction wires instead of a winding that continuous from one blade to an opposite (180° opposite) blade. The field coils all produce a magnetic field in the same radial direction, in FIG. 5 inwards. All conduction wires of all wings will then induce current in the same direction. The wires may be lead to a single arm leading the induced current to the center of the rotatory part for further feeding to the power outlet 8 via the rotary electrical connection 6. In this configuration each wire produces its own current without the need of an opposite blade for a supporting a winding. It is then possible to have an odd number of wings if desired for wind performance reasons.

In FIG. 6, a second rotary part is added to the wind turbine of FIG. 2, although the principle may be adapted for all the wind turbines presented. The second conduction winding 7′ rotates past the magnetic field B on the outside of the field coils 10, 20 making better use of the magnetic field B created by the field coils 10, 20 in expense of wind turbulence issues for the inner rotary part. In FIG. 6, the blades are arranged so that the inner and outer rotary parts rotate in the same direction. It is however obvious to a person skilled in the art that they could just as well rotate in opposite directions to each other.

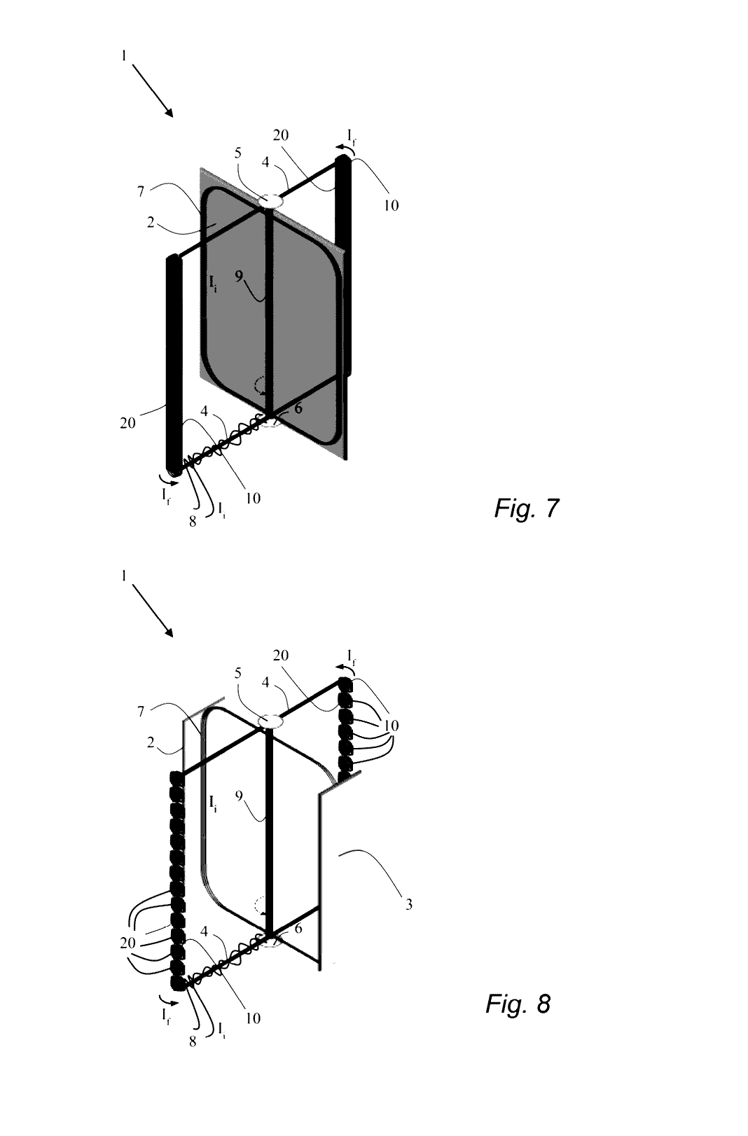

FIG. 7 is a schematic and perspective view of a further embodiment of the present invention having only one blade, and one conduction winding. The blade is directed in the radial direction to the shaft 9 at the axis of rotation. Two field coils 10 are integrated into the supporting structure. The rotary part rotates within the supporting structure. This simple blade structure may be used for simple wind turbines, e.g. in combination with self-extraction chimney ventilators, as the ones placed on top of chimneys to facilitate extra ventilation of the chimney.

FIG. 8 is a schematic and perspective view of a still further embodiment of the present invention having only two blades, and one conduction winding. Fourteen field coils are integrated into each vertical pole of the supporting structure. The rotary part rotates within the supporting structure. Stacking smaller coils 10 on top of each other to create the desired magnetic field B for the conduction winding to move past (as shown in FIGS. 2, 4, 5, and 6) may be advantageous as simple and cheap standardized electromagnets 10, 20 then may be used instead of a custom built electromagnet elongated in the direction of the axis of rotation shown in the embodiments of FIGS. 1 and 3.

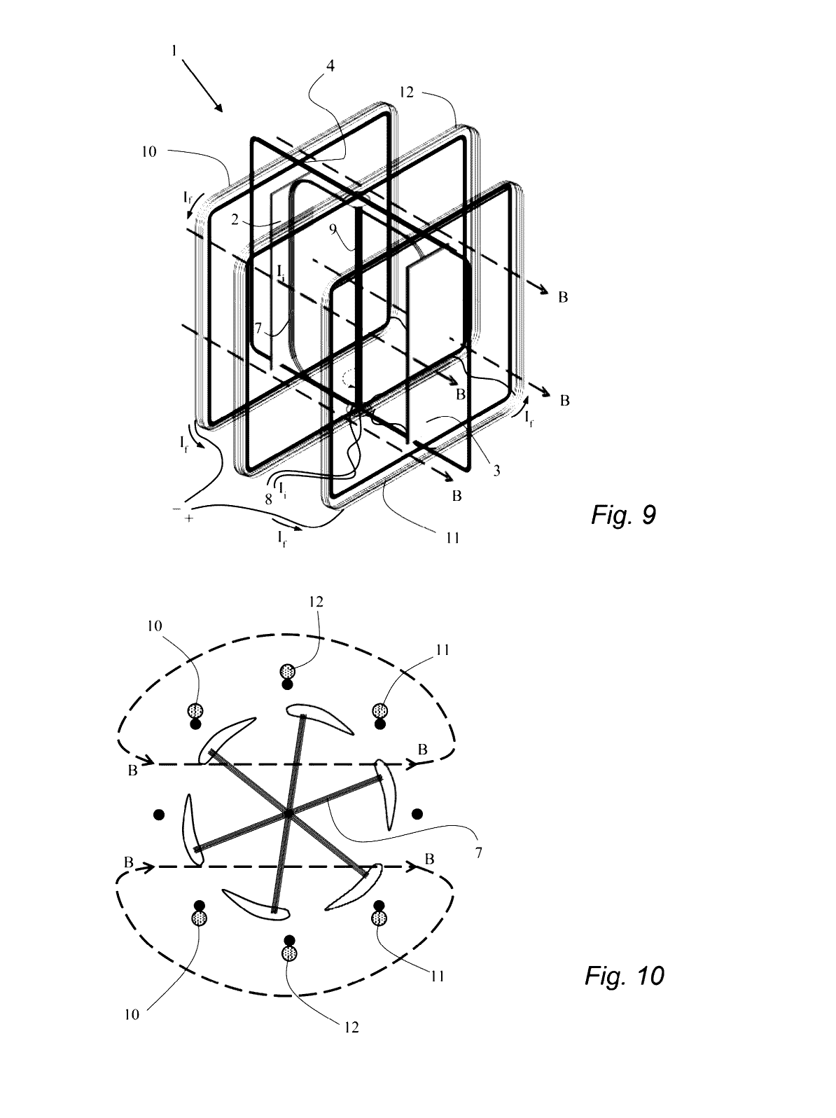

FIG. 9 shows a second aspect of the present invention having three field coils 10, 11, 12 that are wound along the poles of the supporting structure 4, so as to form three parallel coils using the poles of the supporting structure. The field coils 10, 11, 12 are wound in the same direction, connected in series and fed by the direct current I_{f} so as to create a homogenous magnetic field B over the rotating part 2, 3, 7. As the conduction winding 7 rotates in the magnetic field B, a current Iᵢ will be induced in the conducting winding. A rotary electrical connection 6 is facilitated to connect the rotating conducting winding to the output cables for the induced current I_{f}. Direct current part of the induced current I_{f} may be used to feed the field coils their input current I_{f}.

FIG. 10 shows the same wind turbine as in FIG. 9 but with three rotating conduction windings 7 being integrated with three pars of blades, i.e. a total of six blades. The magnetic field B is shown schematically.

It is understood that if the wind turbine has more than one conduction winding the rotary electrical connection 6 and the power outlet 8 may need more wires (not shown) to facilitate the power output. It is also understood that rectifying means (not shown) and other simple electronic components (not shown) have to be attached to the wind turbine of all embodiments to facilitate feeding of the field coils with direct current and to optionally rectify and otherwise adjust the output power to specific needs. For the simplest application, heating water, the shape of the electricity is of no importance, but for many other applications, the electricity will have to be modified using standard components.

1. Wind turbine (1) for converting kinetic energy from wind into electrical power, wherein said wind turbine (1) comprises:
a rotary part (2, 3, 7) adapted to rotate around an axis of rotation (9) comprising at least one blade (2, 3) for catching the wind,
a supporting structure (4, 10, 11, 12, 20) for supporting said rotary part (2, 3, 7) and for fastening said wind turbine (1),
said rotary part (2, 3, 7) being rotably connected to said supporting structure (4) so as to allow rotation of the rotary part (2, 3, 7) with low friction to the supporting structure (4),
characterized in that
at least one field coil (10, 11, 12, 20) is attached to or integrated into said supporting structure (4), said at least one field coil (10, 11, 12, 20) being adapted to be fed with a direct current (I_{f}) so as to create at least one magnetic field (B) with a field direction perpendicular to said axis of rotation (9),
said rotary part (2, 3, 7) comprises at least one conduction wire or winding (7) that is attached to or integrated into said rotary part (2, 3, 7), said conduction wire or winding (7) passing said at least one magnetic field (B) during rotation of said rotary part to induce electric current (Iᵢ) in said conduction wire or winding,
said supporting structure (4) further comprising a rotary electrical connection (6), being adapted to connect said at least one rotating conduction wire or winding (7) of the rotary part (2, 3, 7) to an electrical outlet (8) of said supporting structure.

2. Wind turbine (1) according to claim 1, wherein said conduction wire or winding (7) is integrated in said at least one blade (2, 3) and is arranged along 50-100% of the elongation of said at least one blade (2, 3).

3. Wind turbine (1) according to claim wherein said conduction wire or winding (7) is directed on said at least one blade (2, 3) in a direction parallel to the axis of rotation (9).

4. Wind turbine (1) according to claim 1, wherein each blade (2, 3) has more than one conduction wire or winding (7) attached, the conduction wires or windings (7) being spaced apart in the direction of rotation of the rotary part.

5. Wind turbine (1) according to claim 1, wherein each conduction wire or winding (7) is connected in series to a rectifier unit.

6. Wind turbine (1) according to claim 1, wherein two blades (2, 3) of the rotary part are spaced 180° apart in the rotary direction and span and support at least one conduction winding so that the height of the conduction winding (7) is substantially the same as the height of the blades and the width of the conduction winding (7) is substantially the same as the diameter of the rotary part (2, 3, 7).

7. Wind turbine (1) according to claim 1, wherein said rotary part (2, 3, 7) comprises four or more blades, wherein each blade (2, 3) or each oppositely arranged blade pair span and support one or several conducting winding(s) (7).

8. Wind turbine (1) according to claim 1, wherein the at least one field coil (10, 11, 12) is elongated with a height in a direction parallel to the rotation axis of rotation (9) that is 50-100%, preferably 70-100%, more preferred 80-100%, most preferred 90-100% of the height of the at least one blade.

9. Wind turbine (1) according to claim 1, wherein said at least one field coil (10, 11, 12) is wound around a magnetic core (20) having a permeability that is higher that the permeability of air.

10. Wind turbine (1) according to claim 1, wherein each field coil (10) is integrated in a pole or pillar of the supporting structure (4, 10, 20), said pole or pillar being parallel to said axis of rotation (9).

11. Wind turbine (1) according to claim 1, comprising more than one field coil (10), preferably more than two field coils, most preferably more than three field coils, each field coil being integrated into a pole/pillar of the supporting structure.

12. Wind turbine (1) according to claim 1, wherein said field coils (10) are fed by a parts of the electricity induced (Iᵢ) by the conduction winding, these parts being fed as direct current (DC).

13. Wind turbine (1) according to claim 1, further comprising a second rotary part comprising blades and conduction windings (7′) that are adapted to rotate on the outside of said supporting structure (4, 10, 11, 12, 20).

14. Wind turbine (1) according to claim 1, wherein said blades of said rotary part are adapted to rotate on the outside or the inside of said at least one field coil (10, 11, 12) and said supporting structure.

15. Method for manufacturing a wind turbine (1) according to claim 1, the method comprising the steps of:
mounting and/or integrating conduction winding (7) to the rotary part (2, 3, 7),
mounting the supporting structure (4, 10, 11, 12, 20) to the mounted rotary part (2, 3, 7),
attaching the conduction winding (7) to the rotary electrical connection (6),
arranging or integrating the winding (7) of the at least one field coil (10, 11, 12) to the supporting structure (4, 10, 11, 12, 20),
connecting all field coils (10, 11, 12) in series,
connecting the field coils (10, 11, 12) to a DC source.
